(19) United States
(12) Patent Application Publication
(10) Pub. No.: US 2024/0104806 A1
(43) Pub. Date: Mar. 28, 2024

(54) MODIFICATION OF TARGETED OBJECTS WITHIN MEDIA BACKGROUND

(71) Applicant: INTERNATIONAL BUSINESS MACHINES CORPORATION, ARMONK, NY (US)

(72) Inventors: Stefano Braghin, Dublin (IE); Killian Levacher, Dublin (IE); Hessel Tuinhof, Dublin (IE); Marco Simioni, Dublin (IE)

(21) Appl. No.: 17/935,175

(22) Filed: Sep. 26, 2022

(51) Int. Cl. G06T 11/40

(52) U.S. Cl. CPC G06T 11/40

(57) ABSTRACT

A system may receive inputs including a media, a targeted object keyword list, and a command. The system may feed expanded targeted object keywords into an object detector selector. The system may determine a target object area in the media, by the object detector selector using one or more object detector models. The system may feed the media, and the target object area into an area filler module. The system may generate a background, the area filler module in a target object area of the media.

Aspects of the present disclosure relate to modification of targeted objects within media.

Media editing includes the manipulation and arrangement of pictures and video shots. Media editing is used to structure and present all media information including pictures, stills, films and television shows, video advertisements and video essays. Media editing has been dramatically democratized in recent years by editing software available for personal computers.

### BRIEF SUMMARY

The present disclosure provides a method, computer program product, and system of modification of targeted objects within media. In some embodiments, the method includes receiving inputs including a media, a targeted object keyword list, and a command; feeding expanded targeted object keywords into an object detector selector; determining a target object area in the media, by the object detector selector using one or more object detector models; feeding the media, and the target object area into an area filler module; and generating a background, the area filler module in a target object area of the media.

Some embodiments of the present disclosure can also be illustrated by a computer program product comprising a computer readable storage medium having program instructions embodied therewith, the program instructions executable by a processor to cause the processors to perform a method, the method comprising receiving inputs including a media, a targeted object keyword list, and a command; feeding expanded targeted object keywords into an object detector selector; determining a target object area in the media, by the object detector selector using one or more object detector models; feeding the media, and the target object area into an area filler module; and generating a background, the area filler module in a target object area of the media.

Some embodiments of the present disclosure can also be illustrated by a system comprising a processor and a memory in communication with the processor, the memory containing program instructions that, when executed by the processor, are configured to cause the processor to perform a method, the method comprising receiving inputs including a media, a targeted object keyword list, and a command; feeding expanded targeted object keywords into an object detector selector; determining a target object area in the media, by the object detector selector using one or more object detector models; feeding the media, and the target object area into an area filler module; and generating a background, the area filler module in a target object area of the media.

### BRIEF DESCRIPTION OF THE DRAWINGS

FIG. 1 depicts a computer system according to various embodiments of the present invention.

FIG. 2 illustrates an example system for modification of targeted objects within media, according to various embodiments of the present invention.

FIG. 3 illustrates an example method for modification of targeted objects within media, according to various embodiments of the present invention.

### DETAILED DESCRIPTION

Aspects of the present disclosure relate to modification of targeted objects within media. While the present disclosure is not necessarily limited to such applications, various aspects of the disclosure may be appreciated through a discussion of various examples using this context.

Neural networks may be trained (e.g., machine learning) to recognize patterns in input data by a repeated process of propagating training data through the network, identifying output errors, and altering the network to address the output error. Training data that has been reviewed by human annotators is typically used to train neural networks. Training data is propagated through the neural network, which recognizes patterns in the training data. Those patterns may be compared to patterns identified in the training data by the human annotators in order to assess the accuracy of the neural network. Mismatches between the patterns identified by a neural network and the patterns identified by human annotators may trigger a review of the neural network architecture to determine the particular neurons in the network that contributed to the mismatch. Those particular neurons may then be updated (e.g., by updating the weights applied to the function at those neurons) in an attempt to reduce the particular neurons' contributions to the mismatch. This process is repeated until the number of neurons contributing to the pattern mismatch is slowly reduced, and eventually the output of the neural network changes as a result. If that new output matches the expected output based on the review by the human annotators, the neural network is said to have been trained on that data.

Once a neural network has been sufficiently trained on training data sets for a particular subject matter, it may be used to detect patterns in analogous sets of live data (i.e., non-training data that have not been previously reviewed by human annotators, but that are related to the same subject matter as the training data). The neural network's pattern recognition capabilities can then be used for a variety of applications. For example, a neural network that is trained on a particular subject matter may be configured to review live data for that subject matter and predict the probability that a potential future event associated with that subject matter will occur.

However, accurate event prediction for some subject matters relies on processing live data sets that contain large amounts of data that are not structured in a way that allows computers to quickly process the data and derive a target prediction (i.e., a prediction for which a probability is sought) based on the data. This “unstructured data” may include, for example, various natural-language sources that discuss or somehow relate to the target prediction (such as blog posts, news articles, and social-media posts and messages), uncategorized statistics that may relate to the target prediction, and other predictions that relate to the same subject matter as the target prediction. Further, achieving accurate predictions for some subject matters is difficult due to the amount of sentiment context present in unstructured data that may be relevant to a prediction. For example, the relevance of many social-media and blog posts to a prediction may be based almost solely on the sentiment context expressed in the post. Unfortunately, computer-based event prediction systems such as neural networks are not currently capable of utilizing this sentiment context in target predictions due, in part, to a difficulty in differentiating sentiment-context data that is likely to be relevant to a target prediction from sentiment-context data that is likely to be irrelevant to a target prediction. Without the ability to identify relevant sentiment-context data, the incorporation of sentiment analysis into neural-network prediction analysis may lead to severe inaccuracies.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

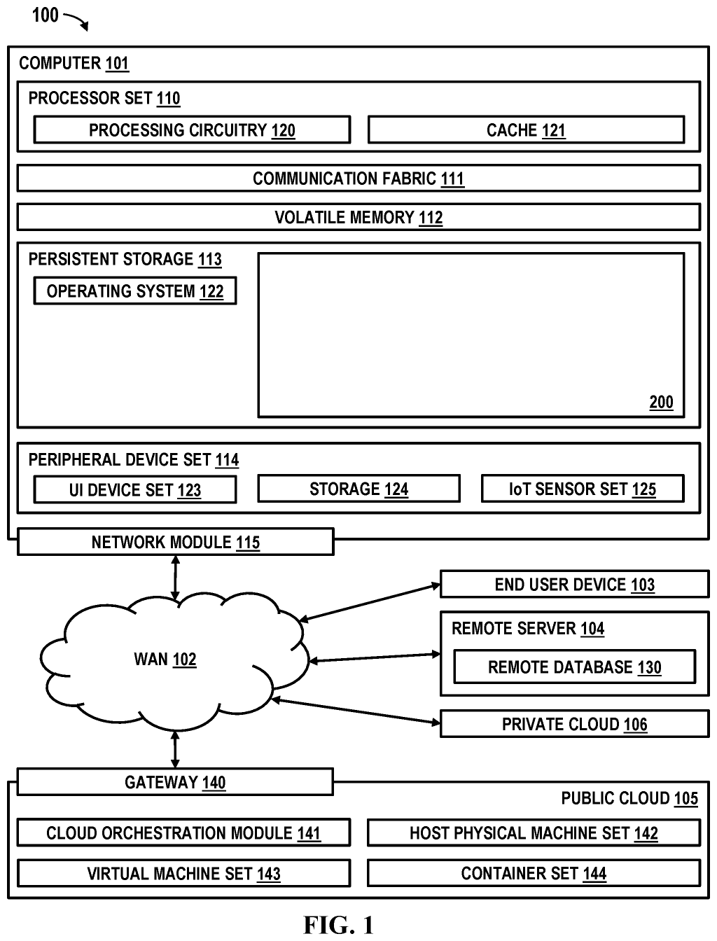

In FIG. 1, computing environment 100 contains an example of an environment for the execution of at least some of the computer code involved in performing the inventive methods, such as [modification of targeted objects within media. In addition to media modification engine 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and engine 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in engine 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in engine 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Visual media (images, video, etc.) represents one of the most common forms of content available and is used in nearly every industry.

However, a large amount of this media content in its original form must be modified before being used. There is an endless list of reasons why such modifications should occur. Some of these reasons can include the need to remove personal information (PI) present within the media (e.g., license plates, people's faces etc.), brands to be removed (e.g., competing brands, 21st century brand present in a movie shot taking place in the 17^{th} century, etc.), replacing one person with another (e.g., replacing a stunt double's face with a lead actor's face), and removing a person or thing that is out of place (e.g., removing a camera man), among others.

In many cases, such modifications require the media to be replaced entirely (e.g., where a photographer must reshoot a scene with different models).

Applying such modifications to media is particularly difficult since removing/replacing problematic objects contained within a targeted area of the media must be modified in such a way that it merges meaningfully with the neighbouring areas. The resulting media should not raise any suspicions from the viewer that it was modified at all.

In parallel to these developments, the field of artificial intelligence and in particular generative artificial intelligence (AI) (e.g., Deep Generative Models, Generative adversarial networks (GANs), Deepfake generators, etc.) has made tremendous progress over the last 10 years. Generative models are now capable of generating synthetic objects which look as realistic as their organic counterparts. Such techniques are already being used to successfully replace Personal Information objects within media with equivalent synthetic objects. These services, however, still require a significant amount of manual labour. Objects can only be replaced if they consist of a pre-defined small list of supported objects (e.g., license plate, people's faces, etc.).

This invention proposes a service which uses artificial intelligence to modify any given media (e.g., images or video) by replacing and/or removing a set of targeted objects.

Therefore, in some embodiments, a system, computer program product, and method for the automated replacement/removal of targeted objects within media content with a media modification engine are presented herein. In some embodiments, the media modification engine may receive input including a media content item (e.g., an image or video), a list of targeted object keywords, a command to replace or remove targeted objects, and/or a list of replacement object keywords. In some embodiments, the media modification engine may return, as output, the media content with targeted objects replaced/removed and an indication of what part of the media was changed. In some embodiments, the media modification engine may use semantic graph networks, object detector/classifiers, and/or deep generative models.

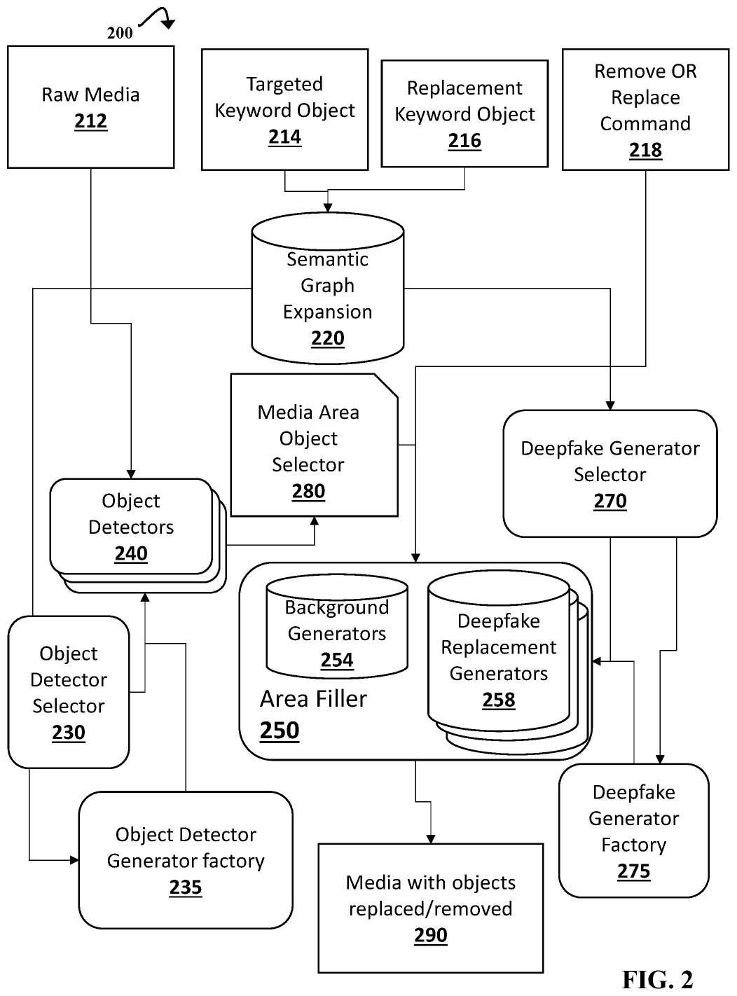

FIG. 2 depicts an example media modification engine 200 for modification of targeted objects within media. In some embodiments, engine 200 may receive one or more data objects including raw media data 212, targeted keyword(s) object 214, replacement keyword(s) object 216 (if a replacement is to be performed), and a remove or replace command 218. In some instances, for explanation purposes, the media modification engine is described with examples using single media inputs. In some embodiments, the media modification engine may be deployed to modify thousands of images/videos with broad categories of targeted keywords objects 214 (e.g., replace any brand, any license place from New Jersey, etc.). For example, if two images are input, one containing a can of cola and another a can of water, if the target object keyword “drink” is input, the invention may replace both the can of cola and water without any additional input. In some embodiments, raw media 212 may be image or video files. In some embodiments, object replacements/removal in videos may require continuity across frames so as to be consistent. In some embodiments, targeted keyword(s) object 214 are the objects that are to be replaced or removed in the media. For example, if a car is to be replaced with a bicycle, the targeted object keyword may be “car” or “vehicle.” In some embodiments, replacement keyword list may be keywords for the replacement objects. Following the previous example, the keyword may be “bicycle.” In some embodiments, the command may be “remove or replace.” For example, if an object is to be removed and background filled in, the remove command may be used. In another example, if the object is to be replaced with another object, a replace command may be used. In some embodiments, targeted keyword(s) object 214 and replacement keyword object 216 may be lists or other data structures having one or more entries or words.

In some embodiments, engine 200 may use a semantic graph expansion 220 to expand the targeted keyword(s) object 214 or the replacement keyword(s) object 216. In some instances, semantic graph expansions are used to define the relationships between disparate facts and provide context for those facts. Graphs are semantic if the meaning of the relationships is embedded in the graph itself and exposed in a standard format. In some embodiments, semantic graph expansion describes a family of specific methodologies to allow the exchange of information about relationships in data in machine-readable form, whether it resides on the web or within organizations. Knowledge graphs (KG) are effective tools for capturing and structuring a large amount of multi-relational data, which can be explored through query mechanisms. Considering their capabilities, KGs are becoming the backbone of different systems, including semantic search engines, recommendation systems, and conversational bots. In the case of structured sources, such as tables (CSV, HTML tables, relational databases, etc.) and tree-based structures (XMLs, JSONs, etc.), the integration strategy is to map their local schemas to the global schema represented by the target ontologies. A semantic model is a powerful tool for representing the mapping for two main reasons. In the first place, a semantic model frames the relations between ontology classes as paths in the graph. Secondly, semantic model enables the computation of graph algorithms to detect the correct mapping.

The implementation of the semantic model approach includes the ontology axioms being represented in a graph structure. The ontology can be seen as a directed, typed, labeled, and multi-relational graph.

The graph nodes represent the classes defined by the ontology. The edges represent the different types of property in terms of object properties, data properties, and subclass relations. Based on the ontology graph, the mapping can be framed into the semantic model (e.g., a directed and labeled graph), whose leaf nodes represent the data source's attributes. The other parent nodes and edges derive from the classes and the properties defined in the ontology.

In some embodiments, object detectors 240 are designed to extract objects from raw media 212 and object detector selectors 230 selects one or more objects for removal. Object detector generator factory 235 may generate one or more object detectors as needed by the words received from the semantic graph expansion 220.

Object recognition is a general term to describe a collection of related computer vision tasks that involve identifying objects in digital photographs.

Image classification involves predicting the class of an object in an image. Object localization refers to identifying the location of one or more objects in an image and drawing abounding box around their extent. Object detection combines these two tasks and localizes and classifies one or more objects in an image. In some instances, object recognition may be used synonymously with object detection. In some embodiments, object recognition may encompass both image classification (a task requiring an algorithm to determine what object classes are present in the image) as well as object detection (a task requiring an algorithm to localize all objects present in the image). Thus, the engine 200 may perform several distinct tasks including: image classification (e.g., the prediction of type or class of an object in an image); object localization (e.g., locating the presence of objects in an image and indicating their location with a bounding box); and object detection (e.g., the location of objects with a bounding box and types or classes of the located objects in an image).

Further, the object localization may include object segmentation, also called object instance segmentation or semantic segmentation, where instances of recognized objects are indicated by highlighting the specific pixels of the object instead of a coarse bounding box.

In some instances, image classification may utilize one or more algorithms to produce a list of object categories present in the image. For example, algorithms may be used to produce a list of object categories present in the image, along with an axis-aligned bounding box indicating the position and scale of one instance of each object category.

In some embodiments, object detection may include the use of algorithms to produce a list of object categories present in the image along with an axis-aligned bounding box indicating the position and scale of every instance of each object category. In some embodiments, media area object selector 280 identifies areas in the media (e.g., photo or frames of a video) that include the detected objects.

In some embodiments, area filler 250 includes a background generator 254 and deepfake replacement generators 258. In some embodiments, the background may be generated for both a remove command and a replace command. In some embodiments, the background generator 254 utilizes a type of neural network called an autoencoder. An autoencoder consists of an encoder, which reduces an image to a lower dimensional latent space, and a decoder, which reconstructs the image from the latent representation. For example, the selected object may be removed leaving a latent space. Background generator 254 may sample the surrounding background and fill in the latent space based on the surrounding background. The engine 200 may use machine learning and a neural network to generate the background to fill in the latent space.

In some embodiments, one or more deepfake replacement generators 258 are selected by deepfake generator selector 270. If the correct deepfake replacement generator is not available, deepfake generator factory 275 may create a deepfake replacement generator for inclusion in deepfake replacement generators 258.

In some instances, generating and managing deepfakes describes a system, process, or method used to replace one item with another. Some examples include replacing one face with another in a video, replacing beverages with hamburgers, and/or replacing cars with bicycles. In some embodiments, deepfakes utilize a type of neural network called an autoencoder (described above). In some instances, deepfakes have a universal encoder which encodes a person or object into the latent space. The latent representation contains key features about facial features, body posture, placement, positioning, lighting, and other visual qualities. In some instances, the features can then be decoded with a model trained specifically for the target. Thus, the target object's detailed information will be superimposed on the latent space (previously occupied by the object to be replaced) of the original media.

In some instances, the background generator 254 creates new images from the latent representation of the source material, while the discriminator attempts to determine whether or not the image is generated. In some embodiments, area filler 250 generates media with the selected objects removed or replaced 290. For example, if the command is “remove all beverages,” engine 200 may remove the beverage and fill in the background of the latent space. In another example, if the command is “replace all beverages with sandwiches,” the engine 200 may remove a beverage, fill in the background, and generate a sandwich where the beverage previously was. In some embodiments, replace commands may require the background to be filled in to avoid latent space that is not taken up by the replacement object (e.g., a bicycle may not fill in all of the space taken up by a car).

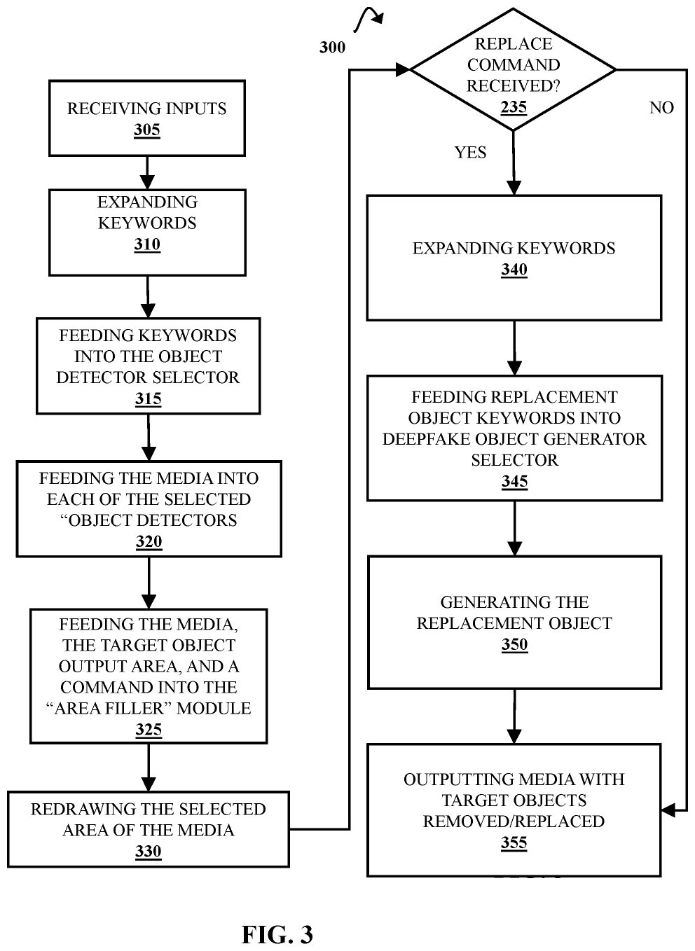

FIG. 3 depicts an example method 300 for modification of targeted objects within media. Operations of method 300 may be enacted by one or more computer systems such as the system described in FIG. 1 above.

Method 300 begins with operation 305 of receiving inputs including a media (e.g., image or video) or sets of media, targeted object keywords (e.g., necklace, license plate, water cans, etc.) describing target objects in the media, a command to replace or remove the target objects, and/or replacement object keywords describing what replacement objects to use to replace targeted objects. In some embodiments, a remove command is an instruction to remove an object from the media, and replace command is an instruction to remove and replace an object within the media. For example, a command to remove cars may remove one or more cars from a picture, where as a command to replace cars with bicycles may remove a car and place a bicycle in a picture.

Method 300 continues with operation 310 of feeding targeted object keywords and/or replacement object keywords into the semantic graph expansion module (e.g., semantic graph expansion 220) which adds additional relevant keywords to targeted object keywords and/or replacement object keywords. It could for example, the feeding may be achieved use open linked data to walk through a semantic graph with the input keywords as a starting node in order to find synonyms of the keywords or subsets of these keywords (e.g., if the keyword input was fruit, subsets could be apple, banana etc). In some embodiments, the semantic graph may be built internally by the media modification engine or received from another source.

Method 300 continues with operation 315 of the feeding expanded targeted object keywords into the “object detector selector” which selects one or more object detector models relevant for each keyword. Following the example from above, if the original input keyword list was [fruit], the expanded list would be [fruit, apple, banana etc.]. In some embodiments, expanded refers to increasing a list of key words to include one or more similar or related keywords that may be used to identify like objects. For example, a keyword list including the word “fruit” may be expanded to include “apple” and “banana.”

In some embodiments, if no suitable object detector is available the “object detector generator factory” produces one for this set of keywords. For example, the module may rely on object detector and deepfake modules directly provided by a user. In another example, the module may rely on off-the-shelf machine learning module libraries to match object keywords with relevant models. In another example, the module may use an auto AI (artificial intelligence) mechanism, relying on keywords provided by users to crawl relevant images online and train such models in a semi-automated fashion.

Method 300 continues with operation 320 of feeding the media into each of the selected “object detectors” that output the area within this media that contains the targeted objects. Following this, method 300 continues with operation 325 of feeding the media, the target object output area, and a command (e.g., whether to replace/remove targeted objects) into the “area filler” module. Method 300 continues with operation 330 where the “area filler” redraws the selected area of the media without the targeted object. In some embodiments, the area filler may generate or redraw the background replacing the removed object. For example, if an image depicted a car in front of a building, after removing the car, the media modification engine may generate a building background to replace the car.

At operation 335, it is determined if a replace command was received. If a replace command was received, the media modification engine may move on to operation 340. If a replace command was not received, the media modification engine may move on to operation 355. Method 300 continues with operation 340 of providing “replacement object keywords,” whereupon these replacement object keywords can be expanded using the “semantic graph expansion” module. For example, if there are not enough suitable keywords provided, the “semantic graph expansion” module generates suitable keywords matching the type of target object keywords provided. For example, if the replacement object keyword list initially included animal and mammal, the semantic graph expansion may add keywords such as, dog, cat, feline, monkey, etc.

Method 300 continues with operation 345 in which the “replacement object keywords” are then fed to the “deepfake object generator selector” which identifies a suitable deepfake generator corresponding to the replacement keyword. For example, if the word bicycle is selected, the media modification engine may select a deepfake generator that is able to generate bicycles. In some embodiments, the identification of a suitable deepfake generator may be performed by matching the keywords (e.g., apple) with a deepfake generator that can generate a fake object of that kind. For example, a neural network generator that can generate images of apples on demand would not be used where the keyword was “motorbike,” instead the media modification engine would select a dedicated neural network generator specialized in generating images of a motorbike.

In some embodiments, if no suitable “deepfake object generator” is available the “deepfake object detector generator factory” produces one for this set of keywords. For example, the module may rely on object detector and deepfake modules directly provided by a user. In another example, the module may rely on off-the-shelf machine learning module libraries to match object keywords with relevant models. In another example, the module may use an auto AI (artificial intelligence) mechanism, relying on keywords provided by users to crawl relevant images online and train such models in a semi-automated fashion.

Method 300 continues with operation 350 of the “area filler” in which the replacement object in the selected media area are generated. Method 300 continues with operation 355 of outputting media with target objects removed/replaced.

What is claimed is:

1. A system comprising:
a memory; and
a processor in communication with the memory, the processor being configured to perform processes comprising:
receiving inputs including a media, a targeted object keyword list, and a command;
feeding expanded targeted object keywords into an object detector selector;
determining, by the object detector selector and using one or more object detector models, a target object area in the media;
feeding both the media and the target object area into an area filler module; and
generating, by the area filler module, a background in a target object area of the media.

2. The system of claim 1, wherein the process further comprises:
receiving a replacement object keyword list.

3. The system of claim 2, wherein the process further comprises:
feeding the replacement object keyword list into a semantic graph expansion module to create additional entries in the replacement object keyword list.

4. The system of claim 3, wherein the process further comprises:
feeding the replacement object keyword list into a deepfake object generator;
identifying a deepfake generator corresponding to the replacement keyword list; and
generating a replacement object.

5. The system of claim 3, wherein the identifying further comprises:
determining that a deepfake generator is unavailable; and
generating, using a deepfake object detector generator factory, the deepfake object detector.

6. The system of claim 1, wherein the process further comprises:
feeding the targeted object keyword list into a semantic graph expansion module to create additional entries in the object keyword list.

7. The system of claim 1, wherein the command is selected from the group consisting of remove and replace.

8. A method comprising:
receiving inputs including a media, a targeted object keyword list, and a command;
feeding expanded targeted object keywords into an object detector selector;
determining, by the object detector selector and using one or more object detector models, a target object area in the media;
feeding the media, and the target object area into an area filler module; and
generating, by the area filler module, a background in a target object area of the media.

9. The method of claim 8, further comprising:
receiving a replacement object keyword list.

10. The method of claim 9, further comprising:
feeding the replacement object keyword list into a semantic graph expansion module to create additional entries in the replacement object keyword list.

11. The method of claim 10, further comprising:
feeding the replacement object keyword list into a deepfake object generator;
identifying a deepfake generator corresponding to the replacement keyword list; and
generating a replacement object.

12. The method of claim 10, wherein the identifying further comprises:
determining that a deepfake generator is unavailable; and
generating, using a deepfake object detector generator factory, the deepfake object detector.

13. The method of claim 8, further comprising:
feeding the targeted object keyword list into a semantic graph expansion module to create additional entries in the object keyword list.

14. The method of claim 8, wherein the command is selected from the group consisting of remove and replace.

15. A computer program product comprising a computer readable storage medium having program instructions embodied therewith, the program instructions executable by a processor to cause the processors to perform a method, the method comprising:
receiving inputs including a media, a targeted object keyword list, and a command;
feeding expanded targeted object keywords into an object detector selector;
determining a target object area in the media, by the object detector selector using one or more object detector models;
feeding both the media, and the target object area into an area filler module; and
generating, by the area filler module, a background in a target object area of the media.

16. The computer program product of claim 15, wherein the method further comprises:
receiving a replacement object keyword list.

17. The system of claim 16, wherein the process further comprises:
feeding the replacement object keyword list into a semantic graph expansion module to create additional entries in the replacement object keyword list.

18. The computer program product of claim 17, wherein the method further comprises:
feeding the replacement object keyword list into a deepfake object generator;
identifying a deepfake generator corresponding to the replacement keyword list; and
generating a replacement object.

19. The computer program product of claim 17, wherein the identifying further comprises:
determining that a deepfake generator is unavailable; and
generating, using a deepfake object detector generator factory, the deepfake object detector.

20. The computer program product of claim 15, wherein the method further comprises:
feeding the targeted object keyword list into a semantic graph expansion module to create additional entries in the object keyword list.
